(19) United States
(12) Patent Application Publication
(10) Pub. No.: US 2026/0155593 A1
(43) Pub. Date: Jun. 4, 2026

(54) CARD EDGE CONNECTOR ASSEMBLY

(71) Applicant: FOXCONN INTERCONNECT TECHNOLOGY LIMITED, Grand Cayman (KY)

(72) Inventor: KUO-CHUN HSU, New Taipei (TW)

(21) Appl. No.: 19/403,557

(22) Filed: Nov. 28, 2025

(30) Foreign Application Priority Data
Nov. 29, 2024 (CN) 202411755515.2

(51) Int. Cl. H01R 12/72; H01R 12/70; H01R 13/42; H01R 13/6581; H01R 31/06

(52) U.S. Cl. CPC H01R 12/721; H01R 12/7082; H01R 12/7088; H01R 13/42; H01R 13/6581; H01R 31/06

(57) ABSTRACT

A card edge connector assembly includes: an electronic card having a first mating portion loaded with plural first gold fingers exposed upon opposite faces thereof and a second mating portion loaded with plural second gold fingers exposed upon opposite faces thereof; and a power adapter, wherein the electronic card has a recess, the second matting portion is disposed within the recess in the mating direction, and the power adapter is assembled to the second mating portion to translate power.

### BACKGROUND OF THE INVENTION

### Field of the Invention

The present invention relates to a card edge connector assembly.

### Description of Related Arts

China Patent Application Publication No. 117826942 discloses a PCIe board which adds a connection unit adjacent to a gold finger unit thereof. A connector is added on the main board to receive the connection unit. The connection unit is substantially flushed with the gold finger unit in the mating direction of the PCIe board, which potentially causes spatial conflicts with other components on the main board.

### SUMMARY OF THE INVENTION

An object of the present invention is to provide an improved card edge connector assembly.

In order to achieve above-mentioned object, a card edge connector assembly comprises: an electronic card having a first mating portion loaded with a plurality of first gold fingers exposed upon opposite faces thereof and a second mating portion loaded with a plurality of second gold fingers exposed upon opposite faces thereof; and a power adapter, wherein the electronic card has a recess, the second matting portion is disposed within the recess in the mating direction, and the power adapter is assembled to the second mating portion to translate power.

Other objects, advantages and novel features of the present invention will become more apparent from the following detailed description of the present embodiment when taken in conjunction with the accompanying drawings.

### BRIEF DESCRIPTION OF DRAWINGS

FIG. 1 is a perspective view of a card edge connector assembly of a first embodiment of this invention , including an electric card, a first card edge connector, a second card edge connector, and an adaptor connected with each other;

FIG. 2 is a perspective view of the assembly in FIG. 1, the assembly is disconnected from each other;

FIG. 3 is a perspective view of the adapter;

FIG. 4 is another perspective view of the adapter in FIG. 3;

FIG. 5 is an exploded perspective view of the adapter in FIG. 3;

FIG. 6 is a further exploded perspective view of a part of the adapter in FIG. 5;

FIG. 7 is a perspective view of the third terminals of the adapter in FIG. 6;

FIG. 8 is a perspective view of the adapter with a shielding shell;

FIG. 9 is an exploded perspective view of the adapter;

FIG. 10 is a perspective view of an assembly of a second embodiment;

FIG. 11 is a perspective view of the adapter in FIG. 10; and

FIG. 12 is an exploded perspective view of the adapter in FIG. 11.

### DETAILED DESCRIPTION OF THE DRAWINGS

Reference will now be made in detail to the preferred embodiments of the present invention.

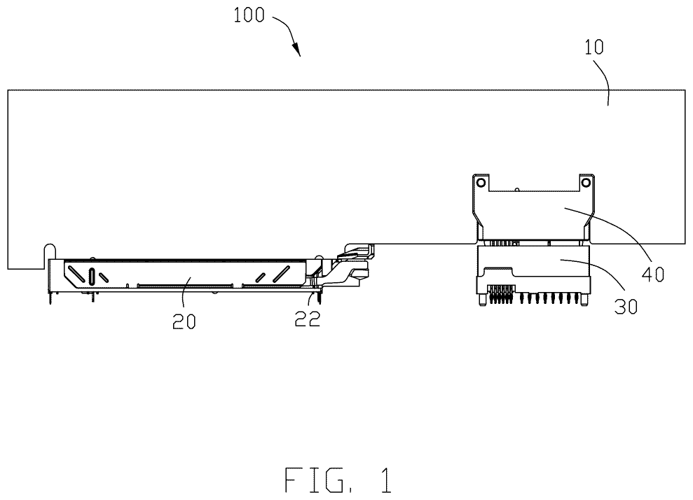

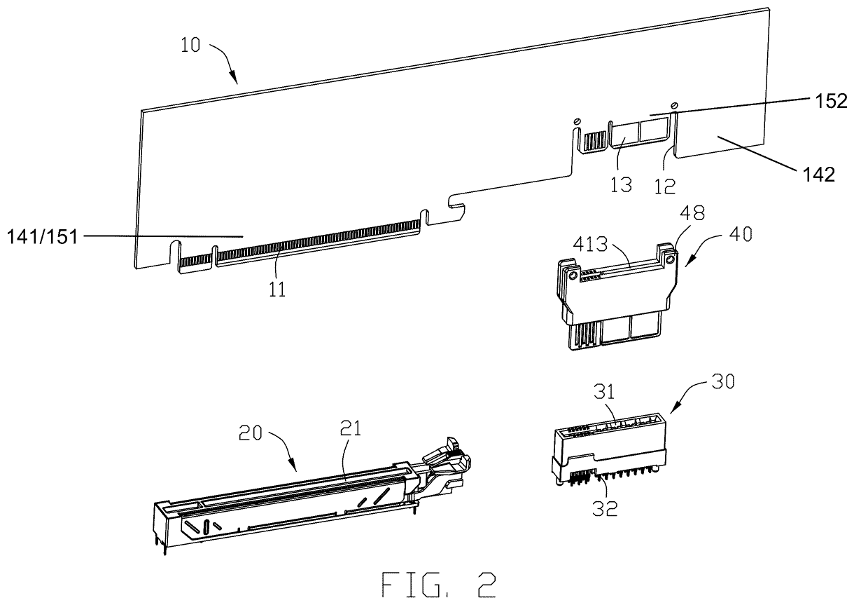

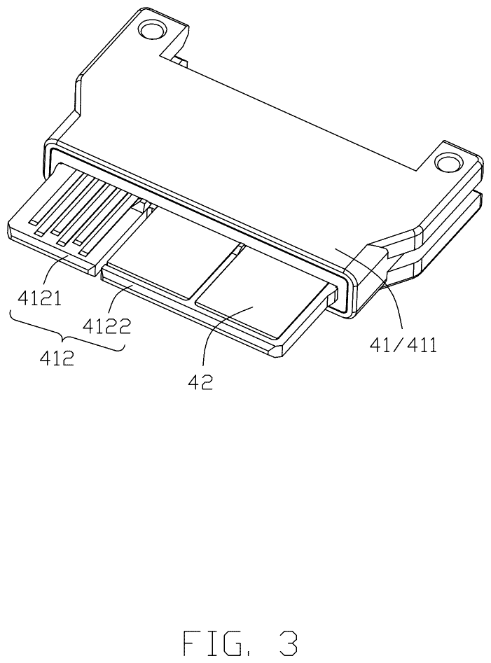

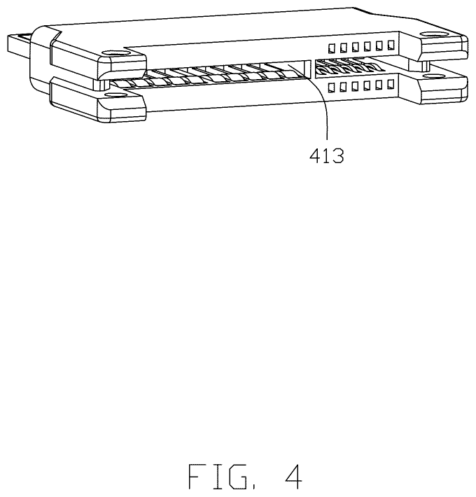

Referring to FIGS. 1-12, a card edge connector assembly 100 includes an electronic card 10, a first card edge connector 20, a second card edge connector 30, and an adapter 40. The first card edge connector 20 includes a first slot 21 and first terminals 22 protruding into the first slot 21. The second card edge connector 30 includes a second slot 31 and second terminals 32 protruding into the second slot 31. The electronic card 10 has first gold fingers 11 on a left/first portion thereof 141 and a plurality of second gold fingers 13 on a right/second portion 142 in a recess 12. The left portion 141 with the first gold fingers 11 forming a first mating portion 151 is used to be inserted into the first slot 21 to contact with the first terminals 22. The right portion with the second gold fingers 13 forming a second mating portion 152, is adapted to connect to the second terminals 32 via the adapter 40.

The first card edge connector 20 and the second card edge connector 30 are used to be mounted on a motherboard or a main circuit board (not shown in figures). The second mating portion 152 with the second gold fingers 13 is located within the recess 12, the lower edges of the second fingers 13 do not extend beyond a lower edge of the card in a mating direction of the card around the recess 12, so as to avoid conflicting with the motherboard, thereby ensuring the compatibility with a standard motherboard. In this embodiment, the second mating portion 152 is a high-power edge connector to add power current. When the electronic card 10 is connected with the motherboard equipped with a high-power edge connector, like the second card edge connector 30, the adapter 40 provides an interposing connection. The adapter connector is used, rather than circuit on the adapter board, the current transmission reliability and capacity are highly improved.

FIGS. 1-9 disclose the adaptor 40 of a first embodiment. The adapter 40 includes a couple of wing portions 48 adjacent to one side of the second gold fingers 13, secured to the electronic card 10 via bolts. Referring to FIGS. 1-4, the adapter 40 includes an insulative housing 41 and third terminals 42 held by the insulative housing 41. The insulative housing 41 has a base portion 411 and a tongue portion 412. The base portion 411 has a third slot 413. The third terminal 42 includes an elastic arm 421 within the third slot 413 and a plate portion 422 exposed on the tongue portion 412. The second gold fingers 13 are inserted into the third slot 413, and the tongue portion 412 is inserted into the second slot 31 to realize the electrical connection through the second gold finger 13, the third terminal 42 and the second terminal 32.

Third terminals 42 include signal terminals 42S, power terminals 42P, and ground terminals 42G arranged in sequence. The power terminal 42P and the ground terminal 42G are plate-shaped for high-current transmission. The tongue portion 412 includes a first tongue portion 4121 and a second tongue portion 4122 extending from the base portion 411. Signal terminals 42S are arranged on the first tongue portion 4121, and the power and ground terminals 42P, 42G are arranged on the second tongue portion 4122.

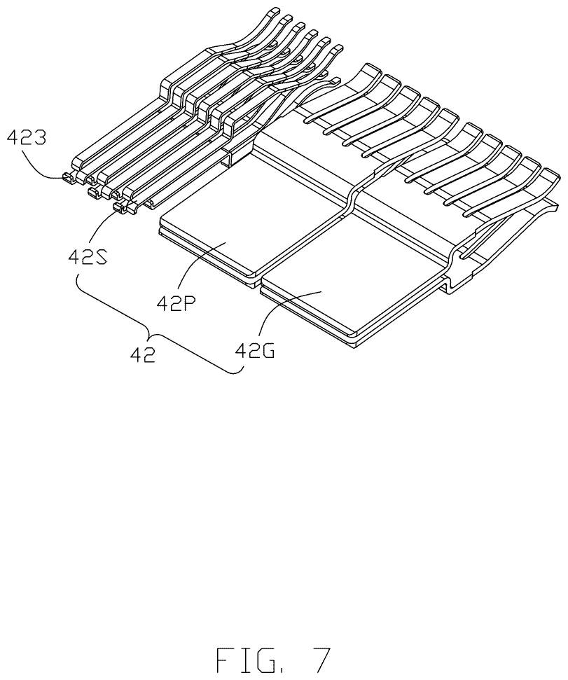

As shown in FIG. 7, two rows of the elastic arms 421 clamp the second gold fingers 13. The plate portion 422 of the signal terminal includes a bent portion 423 at a front thereof. The bent portion 412 is inserted into the tongue portion 412 to keep the signal terminal 42S being fixed on the tongue portion 4121. The bent portions 423 of the opposing signal terminals 42S stagger along the insertion direction.

The insulative housing 41 includes an insulative shell 43 and a terminal module 44 received in the insulative shell 43 and housing the third terminals 42. The insulative shell 43 is retained to the terminal module 44 via buckling engagement, that is, a couple of latching arms 431 on the insulative shell 43 engage with the buckle protrusions 442 by buckle slots 441 of the terminal module 44.

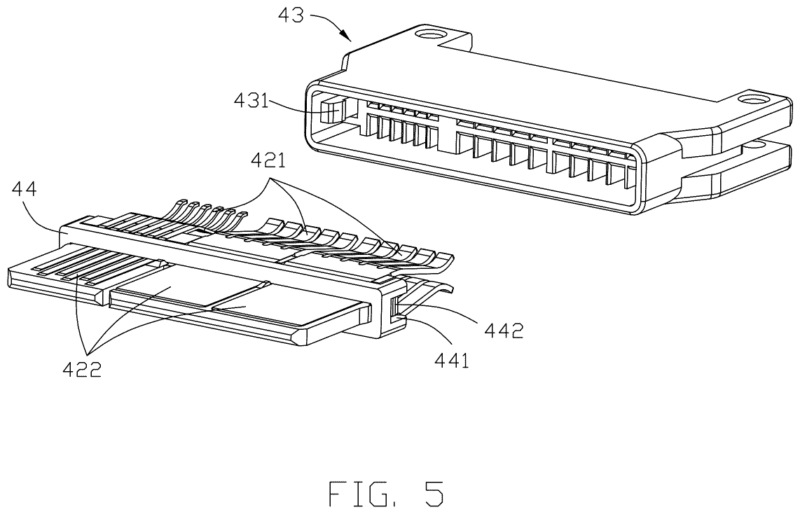

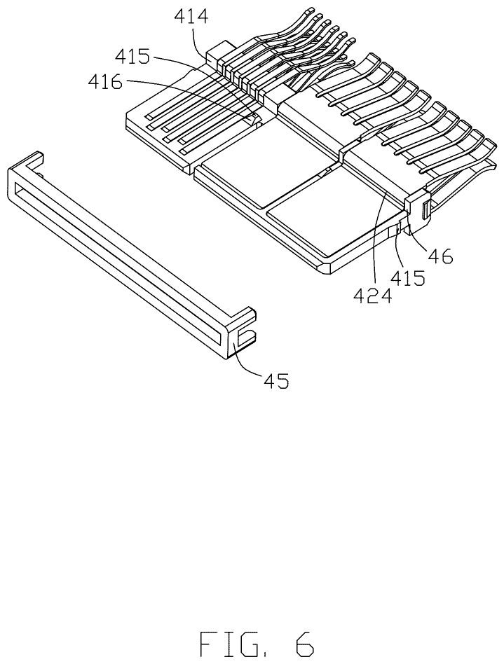

Referring to FIGS. 5-6, the tongue portion 412 includes a step portion 414 adjacent to the base portion 411. In this embodiment, the step portion 414 and the insulative shell 43 form the base portion 411. A limiting member 45 is sleeveed onto the tongue portion 412, pressing the third terminals 42 against the step portion 414 to secure the third terminals between the limiting member 45 and the step portion 414. To be more specific, the limiting member 45 is a frame structure fitting over the tongue portion 412. A limiting protrusion 415 on the tongue portion 412 forms a receiving space 46 with the step portion 414 for the limiting member 45. A guide inclined surface 416 on protrusion 415 guides the limiting member 45 into the receiving space 46 against the third terminals 42, and the third terminal forms a bending portion 424 therebetween.

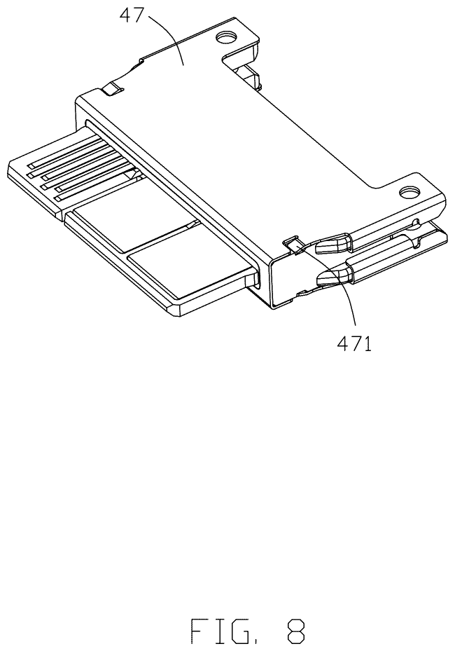

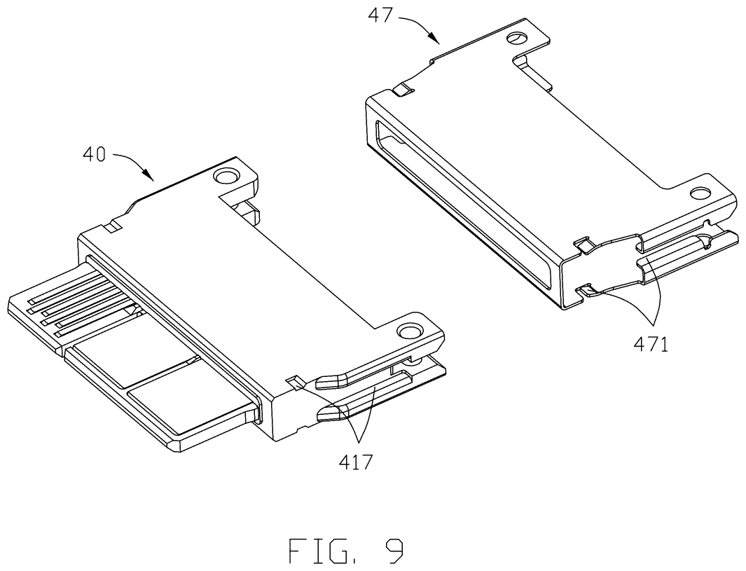

Referring to FIGS. 8-9, the shielding shell 47 covers an outside of the insulative housing 41, plural tabs 471 split from the shielding shell 47 is engaged with holes 417 on the insulative housing for positional retention. A couple of wing portions 48 extend from the insulative housing 41 and are covered with the shielding shell 47. The card is further limited by the wing portions 48, and bolts run through the wing portion to further retain the electronic card 10 with the adapter 40. In particularly, the tabs 471 protrude into the holes 417 on opposite sides of the insulating housing and abut against a limiting faces 4171 of the holes 417 to secure the shielding shell 47.

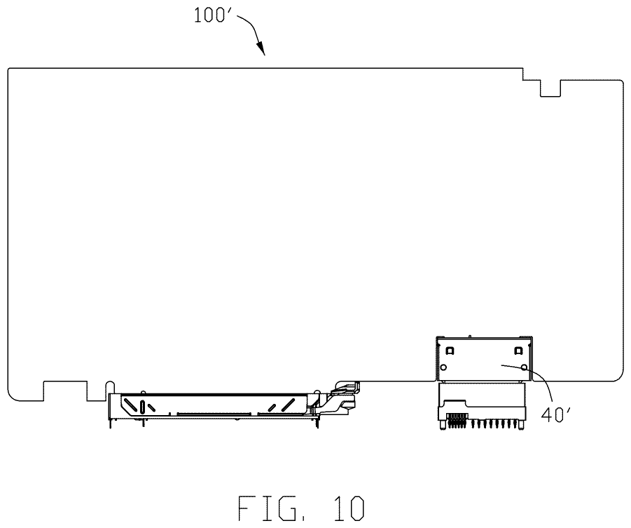

FIGS. 10-12 disclose an adapter 40′ of the second embodiment. Only the difference that the assembly of the third terminal 42′ and the structure of the insulative housing 41′, is described hereinafter.

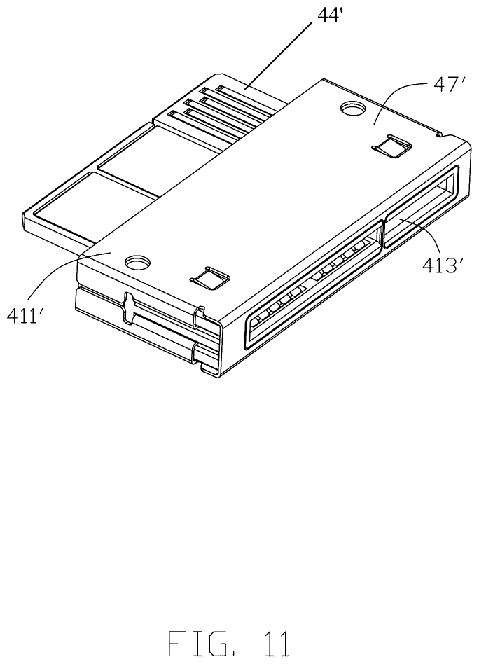

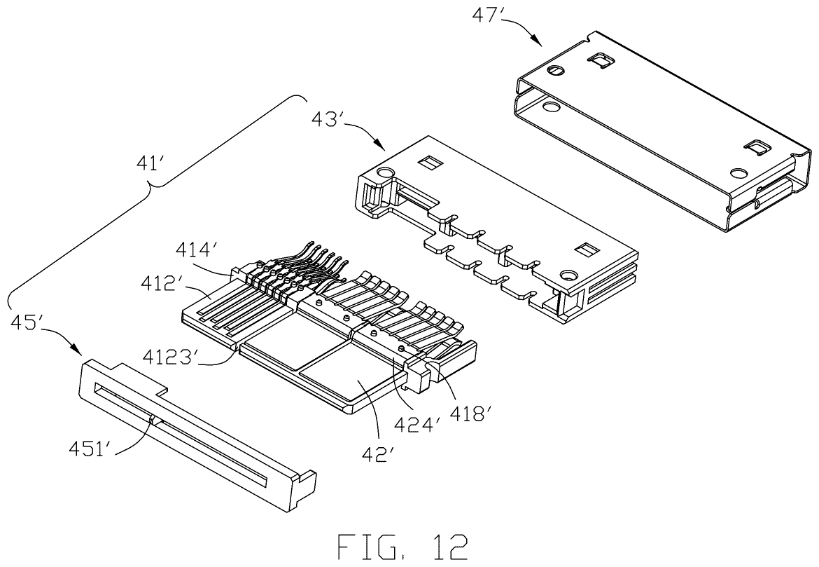

Referring to FIGS. 11-12, the shielding shell 47′ covers an outside of the insulative housing 41′, the shielding shell is retained on the insulative housing by bolts. The insulative housing 41′ includes an insulative shell 43′ and a terminal module 44′ housing third terminals 42′. The insulative shell 43′ is bolted to the terminal module 44′, thereby securing the shielding shell 47′, the insulative shell 43′, and terminal module 44′ together.

The insulative housing 41′ includes a base portion 411′ and a tongue portion 412′. The tongue portion 412′ has a step portion 414′ adjacent to the base portion 411′, sleeved with a limiting member 45′. The base portion 411′ has a plurality of fixing posts 418′ penetrating the third terminals 42′ to secure them. The tongue portion 412′ includes a first tongue portion 4121′ and a second tongue portion 4122′ extending from base portion 411′, separated by a gap 4123′. The limiting member 45′ is a frame structure sliding over the tongue portion 412′ toward the step portion 414′ to press against the third terminals 42′. The limiting member 45′ is adhered to the step portion 414′, forming bending portions 424′ between the limiting member 45′ and the step portion 414′. In addition, the limiting member 45′ has a key 451′ extending into the gap 4123′ for positioning and fixation.

However, the disclosure is illustrative only, changes may be made in detail, especially in matter of shape, size, and arrangement of parts within the principles of the invention.

1. A card edge connector assembly comprising:
an electronic card comprising a left portion with a plurality of first gold fingers on opposite sides of the left portion and a right portion having a recess and a plurality of second gold fingers on opposite sides of the right portion and located in the recess;
a first card edge connector having a first slot and plural first terminals protruding in the first slot;
a second card edge connector having a second slot and plural second terminals protruding in the second slot; and
an adapter;
wherein the first gold fingers are inserted into the first slot and are mechanically and electrically connected with the first terminals, and the second fingers are inserted in the adaptor, and the adaptor is inserted in the second slot and the second gold fingers are electrically connected to the second terminals via the adapter.

2. The card edge connector assembly as claimed in claim 1, wherein the electronic card has a second mating portion located within the recess.

3. The card edge connector assembly as claimed in claim 1, wherein:
the adapter comprises an insulative housing and a plurality of third terminals fixed in the insulative housing;
the insulative housing comprises a base portion and a tongue portion, and each of the third terminals comprises an elastic arm protruding in a third slot of the base portion and a plate portion exposed to the tongue portion; and
the second gold fingers are inserted in the third slot, and the tongue portion is inserted in the second slot to electrically connect the second gold fingers, the third terminals, and the second terminals.

4. The card edge connector assembly as claimed in claim 3, wherein the third terminals comprise plural signal terminals, plural power terminals, and ground terminals arranged in sequence, and the power terminals and the ground terminals are plate-shaped structures.

5. The card edge connector assembly as claimed in claim 3, wherein the adapter comprises a shielding shell covering an outside of the insulative housing and is bolted to the insulative housing.

6. The card edge connector assembly as claimed in claim 2, wherein the second mating portion extends up to the right portion in a mating direction of the electronic card.

7. An adapter comprising:
an insulative housing; and
a plurality of third terminals retained in the insulating housing;
wherein the insulative housing comprises a base portion having a third slot and a tongue portion extending from the base portion, and each of the third terminals comprises an elastic arm located in the third slot and a plate portion exposed upon the tongue portion.

8. The adapter as claimed in claim 7, wherein the insulative housing comprises an insulative shell and a terminal module therein, the third terminals are fixed to the terminal module, and the insulative shell is bolted or buckled to the terminal module.

9. The adapter as claimed in claim 7, wherein the tongue portion comprises a first tongue portion and a second tongue portion extending from the base portion, the third terminals comprise signal terminals disposed on the first tongue portion, the power terminals and ground terminals are disposed on the second tongue portion.

10. The adapter as claimed in claim 7, wherein the tongue portion has a step portion adjacent to the base portion, and a limiting member is sleeved around the step portion and presses the third terminals against the step portion.

11. A card edge connector assembly comprising:
an electronic card having a first mating portion loaded with a plurality of first gold fingers exposed upon opposite faces thereof and a second mating portion loaded with a plurality of second gold fingers exposed upon opposite faces thereof; and
a power adapter;
wherein the electronic card has a recess, the second matting portion is disposed within the recess in the mating direction, and the power adapter is assembled to the second mating portion to translate power.

12. The card edge connector assembly as claimed in claim 11, wherein:
the power adaptor comprises an insulative housing and power terminals;
the insulative housing comprises a base portion with a third slot and a tongue portion;
the power terminals comprise elastic arms within the third slot and plate portions exposed upon the tongue portion; and
the second mating portion is inserted into the third slot.

13. The card edge connector assembly as claimed in claim 12, wherein the tongue portion has a step portion adjacent to the base portion, and a limiting member is sleeved around the step portion and presses the plate portions against the step portion.

14. The card edge connector assembly as claimed in claim 13, wherein the tongue portion includes a limiting protrusion forming a receiving space with the step portion for the limiting member.

15. The card edge connector assembly as claimed in claim 14, wherein the limiting member is a frame structure fitting over the tongue portion.
